(19) United States
(12) Patent Application Publication
(10) Pub. No.: US 2009/0315516 A1
(43) Pub. Date: Dec. 24, 2009

(54) POWER SUPPLY SYSTEM

(76) Inventor: Deok-Kwan Choi, Yongin-si (KR)

Correspondence Address: SHERR & VAUGHN, PLLC, 620 HERNDON PARKWAY, SUITE 320, HERNDON, VA, 20170, US

(21) Appl. No.: 12/482,953

(22) Filed: Jun. 11, 2009

(30) Foreign Application Priority Data
Jun. 18, 2008 (KR) 2008-0057452

(51) Int. Cl. H02J 7/00

(52) U.S. Cl. 320/116

(57) ABSTRACT

A power supply system for a vehicle is provided which makes it easy to supply an ignition voltage to an electronic control unit by using a battery equalizer. The power supply system for a vehicle comprises: an electronic control unit; a battery unit supplying a battery voltage to the electronic control unit; and a battery equalizer supplying the battery voltage as an ignition voltage to the electronic control unit; wherein, the battery equalizer includes a transistor transmitting the battery voltage from the battery unit to the electronic control unit as the ignition voltage when the vehicle is ignited.

This application claims priority over the benefits of Korean Application No. 2008-0057452 filed on Jun. 18, 2008 in the Korean Intellectual Property Office, the disclosure of which is incorporated by reference.

### BACKGROUND OF THE INVENTION

1. Field of the Invention

The present invention relates to a power supply system for a vehicle, and more particularly, to a power supply system for a commercial car which makes it easy to supply an ignition voltage to an electronic control unit by using a battery equalizer.

2. Discussion of the Related Art

Generally, a power supply system for a commercial vehicle (such as a bus, truck, etc.) is a 24V power supply system. Battery unit in a power supply system is charged when the vehicle is ignited. Electronic control unit is operated by a voltage which is supplied from the battery unit or ignition unit. Components in the electronic control unit which are needed to be operated only when the vehicle is ignited are operated by the voltage supplied from the ignition unit. However, components in the electronic control unit which are needed to be supplied voltage whether or not the vehicle is ignited are operated by the battery voltage.

In a 24V power supply system, battery unit comprises two 12V batteries connected in series. Battery Equalizer(BEQ) applied in the power supply system helps the balancing of the voltage between the two serial-connected batteries, such that the voltage between the two batteries maintain 12V.

When an electronic control unit designed for 12V power supply system is applied to a vehicle with a 24V power supply system, Battery Equalizer supplies 12V voltage to the electronic control unit. AV equipment, such as car audio systems, and electronic devices, which are mounted on a vehicle, are generally designed for 12V voltage.

Conventionally, when an electronic control unit designed for 12V power supply system is applied to a 24V power supply system, Battery Equalizer down convert 24V voltage to 12V voltage. Battery Equalizer transmits the converted 12V voltage to the electronic control unit. Battery equalizer converts the voltage using a DC-DC converter.

However, the use of DC-DC converter increases the cost of the power supply. Moreover, when a relay is used to transmit a battery voltage to the electronic control unit, noise increases.

### SUMMARY OF THE INVENTION

It is an object of the present invention to provide a power supply system for a commercial vehicle which makes it easy to supply a battery voltage as an ignition voltage to an electronic control unit by using a battery equalizer.

To achieve the foregoing object, there is provided a power supply system for a vehicle, comprising: an electronic control unit; a battery unit supplying a battery voltage to the electronic control unit; and a battery equalizer supplying the battery voltage as an ignition voltage to the electronic control unit; wherein, the battery equalizer includes a transistor transmitting the battery voltage from the battery unit to the electronic control unit as the ignition voltage when the vehicle is ignited.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a functional block diagram schematically showing a power supply system for a commercial vehicle according to the present invention; and

FIG. 2 is a schematic circuit diagram showing a battery equalizer of FIG. 1.

### DETAILED DESCRIPTION OF THE PREFERRED EMBODIMENTS

A power supply system for a vehicle according to the present invention will be described in detail with reference to the accompanying drawings.

There may exist a plurality of exemplary embodiments of a power supply system for a commercial vehicle, of which the most preferred one will now be described.

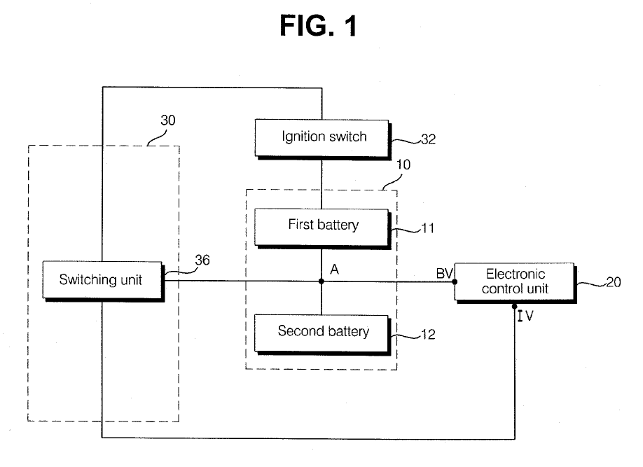

FIG. 1 is a functional block diagram schematically showing a power supply system for a commercial vehicle according to the present invention.

Referring to FIG. 1, this power supply system for a vehicle comprises a battery unit 10 including at least one battery, an electronic control unit 20 using a battery voltage transmitted from the battery unit 10, and a battery equalizer 30 for transmitting the battery voltage as an ignition voltage to the electronic control unit 20.

In this exemplary embodiment, battery unit 10 comprises of two 12V batteries 11, 12 connected in series. However, it may be possible to comprise the battery unit with more or less than two batteries connected in series or parallel.

The battery unit 10 is charged when a vehicle is ignited. Ignition switch 32 is switched on when a vehicle is ignited such that a voltage generated from an ignition unit is supplied to the battery unit 10. In a 24V power supply system, voltage generated by the ignition unit is 24V. The generated voltage is charged in the battery unit 10.

Battery unit 10 supplies battery voltage to the electronic control unit 20. Electronic control unit includes components operated by voltage. The components are either operated by battery voltage supplied by the battery unit or battery voltage supplied as an ignition voltage via battery equalizer 30. The battery voltage and ignition voltage are 12V.

Components which are operated by voltage transmitted via BV port are components which should be supplied voltage regardless of the ignition of the vehicle, such as a motor, valve, or actuator. Components which are operated by voltage transmitted via IV port are components which should be supplied voltage when the vehicle is ignited, such as microprocessor, or vehicle control circuits.

The battery equalizer 30 balances the voltages of the two 12V batteries 11, 12 connected in series such that the battery voltage could be stably supplied to the electronic control unit 20. The battery equalizer 30 converts the 24V voltage transmitted via ignition switch 32 to 12V. The converted battery voltage is supplied to the electronic control unit 20 through BV port. The BV port is also connected to the connection point A of the two 12V batteries 11, 12. Hence, the balancing of voltage between the two batteries 11, 12 is sustained.

The battery equalizer 30 transmits the battery voltage from the second battery 12 from the battery unit 10 as an ignition voltage to the electronic control unit 20 via IV port when the vehicle is ignited. Hence, components which should be operated when the vehicle is ignited are supplied voltage.

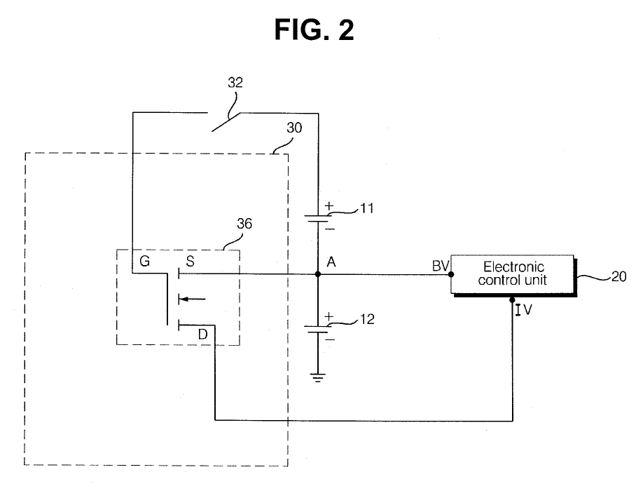

FIG. 2 draws more detail description of the embodiment.

The battery equalizer 30 includes a transistor 36. The transistor 36 is switched on when the ignition switch 32 is turned on. Hence, the transistor 36 transmits the battery voltage of second battery 12 as an ignition voltage to the electronic unit 20.

The transistor 36 can be comprised of N channel MOSFET. The transistor 36 is switched on when a difference in voltage between a Gate G and Source S of the transistor 36 is over 3V. When a vehicle is ignited the ignition switch 32 is switched on. Hence, 24V battery voltage from the battery unit 10 is supplied to the gate G of the transistor 36. The voltage of the source S of the transistor is 12V since the source S is connected to the connection point A, which the voltage is 12V.

Once the transistor 36 is switched on, the 12V battery voltage from the second battery 12 is supplied to the electronic control unit 20 as an ignition voltage. Hence, the supply of the ignition voltage to the electronic control unit 20 is triggered by the ignition of the vehicle.

Here, the battery equalizer 30 may use other parts in addition to the N-channel electric effect transistor 36, but the present invention is not limited thereto.

As described above, the power supply system for a commercial vehicle can reduce the weight, have a simple circuit configuration, realize a stable circuit operation, and reduce the cost by using an electric field effect transistor.

As aforementioned, the exemplary embodiment of the present invention are shown and described, but the present invention is not limited to the exemplary embodiments described above, and can be implemented in various modifications by those skilled in the art to which the present invention pertains without departing from the scope of the present invention recited in the appended claims, and such modifications should not be understood to depart from the technical spirit or prospect of the present invention.

1-8. (canceled)

9. A power supply system for a vehicle, comprising:
an electronic control unit;
a battery unit supplying a battery voltage to the electronic control unit; and
a battery equalizer supplying the battery voltage as an ignition voltage to the electronic control unit;
wherein, the battery equalizer includes a transistor transmitting the battery voltage from the battery unit to the electronic control unit as the ignition voltage when a vehicle ignition switch is turned on.

10. The power supply. system of claim 9, wherein the transistor is a N-channel MOSFET.

11. The power supply system of claim 10, wherein the transistor switches on when the vehicle ignition switch is turned on such that the battery voltage is transmitted to the electronic control unit as the ignition voltage.

12. The power supply system of claim 9, wherein the battery unit comprises a plurality of batteries connected in series.

13. The power supply system of claim 12, wherein the battery unit supplies one of the voltages of the plurality of batteries as the battery voltage.

14. The power supply system of claim 12, wherein the transistor transmits one of the voltages of the plurality of batteries as the ignition voltage.

15. The power supply system of claim 9, wherein the battery voltage and the ignition voltage are 12V.

16. The power supply system of claim 9, wherein the transistor switches on when a difference in voltage between a gate and source of the transistor is over 3V.
